(19) United States
(12) Patent Application Publication
(10) Pub. No.: US 2024/0254821 A1
(43) Pub. Date: Aug. 1, 2024

(54) VEHICLE DOOR CONTROL METHOD AND SYSTEM

(71) Applicant: MAGNA AUTOMOTIVE PARTS (SUZHOU)CO., LTD., Suzhou (CN)

(72) Inventors: Daotian HU, Suzhou (CN); Jinsha YI, Suzhou (CN); Zhenya XU, Suzhou (CN)

(21) Appl. No.: 18/101,720

(22) Filed: Jan. 26, 2023

(30) Foreign Application Priority Data
Jan. 28, 2022 (CN) 202210108209.4

(51) Int. Cl. E05F 15/44; E05F 15/603

(52) U.S. Cl. CPC E05F 15/44; E05F 15/603; E05Y 2400/31; E05Y 2900/531

(57) ABSTRACT

A vehicle door control method and system are provided. The method includes calibrating a disturbing force of a vehicle and determining an operating mode of a vehicle door according to an input instruction and/or a current vehicle door state. Next, determining a vehicle door operating effect according to the operating mode and determining target voltage information of a motor of the vehicle door according to the operating mode, the disturbing force, the current vehicle door state, and vehicle door operating effect. The method also includes controlling the motor to operate according to the target voltage information, so that the motor drives the vehicle door. Accordingly, a torque of the motor may be determined according to the vehicle door operating effect and the disturbing force calibrated before delivery, so as to determine the target voltage information, which achieves self-adaptation and accurate control of the vehicle door.

### CROSS-REFERENCE TO RELATED APPLICATION

This application claims the benefit and priority of Chinese Application No. 202210108209.4, filed Jan. 28, 2022. The entire disclosure of the above application is incorporated herein by reference.

### FIELD

Embodiments of the present invention relate to the technical field of vehicles, and in particular, to a vehicle door control method and system.

### BACKGROUND

This section provides background information related to the present disclosure which is not necessarily prior art.

With the rapid development of vehicle automation technologies, electric vehicle doors are increasingly widely used. The electric vehicle doors include a sliding door and an electric conventional door. A suspending position and an assist effect of the vehicle door are controlled during opening of the electric conventional door.

Currently, in order to control the electric conventional door, a disturbing force of the vehicle door needs to be recognized during the operation of the vehicle door, and then a mathematical model is established to determine a torque of a motor. However, a torque characteristic may vary for different batches of vehicle door actuating components. Moreover, a plurality of sensors are required for detecting the disturbing force, which lead to errors of a suspending position and an assist effect of the conventional door and difficulty in accurately controlling the operation of the electric conventional doors.

In view of the above, there remains a need to develop improved systems for controlling the vehicle doors which address and overcome limitations and drawbacks associated with known systems as well as to provide increased convenience and enhanced operational capabilities.

### SUMMARY

This section provides a general summary of the disclosure, and is not a comprehensive disclosure of its full scope or all of its features.

The present invention provides a vehicle door control method and system, to achieve accurate control of operation of an electric conventional door.

According to a first aspect, an embodiment of the present invention provides a vehicle door control method. The method includes the step of calibrating a disturbing force of a vehicle door. The disturbing force includes at least a frictional force, a gravity, and a wind power. The method proceeds by determining an operating mode of the vehicle door during operation according to an input instruction and/or a current vehicle door state, where the operating mode includes at least a suspending mode, an assist mode, and an electric mode. The method continues with the step of determining a vehicle door operating effect according to the operating mode. Next, determining target voltage information of a motor of the vehicle door according to the operating mode, the disturbing force, the current vehicle door state, and the vehicle door operating effect. The method also includes the step of controlling the motor to operate according to the target voltage information, so that the motor drives the vehicle door to operate.

Optionally, before the determining an operating mode of the vehicle door during operation according to an input instruction and/or a current vehicle door state, the method further includes acquiring the input instruction and/or the current vehicle door state. The acquiring the current vehicle door state includes determining the current vehicle door state according to a current motor state, the disturbing force, and a vehicle body attitude. The current motor state includes at least a present motor current.

Optionally, the determining target voltage information of a motor of the vehicle door according to the operating mode, the disturbing force, the current vehicle door state, and the vehicle door operating effect includes determining target current information of the motor of the vehicle door according to the operating mode, the disturbing force, the current vehicle door state, and the vehicle door operating effect. The determining target voltage information of a motor of the vehicle door according to the operating mode, the disturbing force, the current vehicle door state, and the vehicle door operating effect includes can also include determining the target voltage information according to the target current information.

Optionally, the determining target current information of the motor of the vehicle door according to the operating mode, the disturbing force, the current vehicle door state, and the vehicle door operating effect includes determining a target suspending position when determining that the operating mode is the suspending mode. Next, determining a suspending manner of the vehicle door according to the current vehicle door state, where the suspending manner includes emergency suspension and smooth suspension. In addition, determining an operation trajectory of the vehicle door according to the target suspending position and the suspending manner. The determining target current information of the motor of the vehicle door according to the operating mode, the disturbing force, the current vehicle door state, and the vehicle door operating effect can also include determining a target speed of the motor according to the operation trajectory of the vehicle door, the disturbing force, the current vehicle door state, and the vehicle door operating effect. Next, determining the target current information according to the target speed and the present motor current.

Optionally, the determining the target current information according to the target speed and the present motor current includes performing fuzzification and proportional-integral (PI) control on the target speed and the present motor current, to determine the target current information.

Optionally, the performing fuzzification and PI control on the target speed and the present motor current, to determine the target current information includes obtaining a target acceleration according to the target speed includes performing fuzzification on the target speed and the target acceleration, to obtain a proportional parameter and an integral parameter. Next, performing PI control on the target speed, the proportional parameter, the integral parameter, and the present motor current, to determine the target current information.

Optionally, the determining target current information of the motor of the vehicle door according to the operating mode, the disturbing force, the current vehicle door state, and the vehicle door operating effect includes determining an assist parameter when determining that the operating mode is the assist mode. In addition, determining the target current information of the motor of the vehicle door according to the assist parameter, the disturbing force, the current vehicle door state, and the vehicle door operating effect.

Optionally, the determining target current information of the motor of the vehicle door according to the operating mode, the disturbing force, the current vehicle door state, and the vehicle door operating effect includes planning the operation trajectory of the vehicle door when determining that the operating mode is the electric mode. Next, determining a target position and a target speed of the vehicle door according to the operation trajectory. The determining target current information of the motor of the vehicle door according to the operating mode, the disturbing force, the current vehicle door state, and the vehicle door operating effect includes planning the operation trajectory of the vehicle door when determining that the operating mode is the electric mode can also include determining the target current information of the motor of the vehicle door according to the target position, the target speed, the current motor state, the disturbing force, the current vehicle door state, and the vehicle door operating effect.

Optionally, the determining the target voltage information according to the target current information includes determining DC voltage information according to the target current information. Next, transforming the DC voltage information to space AC voltage information. In addition, transforming the space AC voltage information to space vector pulse width modulation (SVPWM) information. The determining the target voltage information according to the target current information also can include determining the target voltage information according to the SVPWM information.

According to a second aspect, an embodiment of the present invention further provides a vehicle door control system, including a controller and a motor. The controller is configured to calibrate a disturbing force of a vehicle door, where the disturbing force includes at least a frictional force, a gravity, and a wind power. The controller is also configured to determine an operating mode of a vehicle door during operation according to an input instruction and/or a current vehicle door state, where the operating mode includes at least a suspending mode, an assist mode, and an electric mode. The controller is additionally configured to determine a vehicle door operating effect according to the operating mode. The controller determines target voltage information of the motor of the vehicle door according to the operating mode, the disturbing force, the current vehicle door state, and the vehicle door operating effect. The controller is electrically connected to the motor, and the controller is further configured to control the motor to operate according to the target voltage information, so that the motor drives the vehicle door to operate.

Optionally, before the determining an operating mode of the vehicle door during operation according to an input instruction and/or a current vehicle door state, the controller is further configured to acquire the input instruction and/or the current vehicle door state. To acquire the current vehicle door state, the controller is configured to determine the current vehicle door state according to a current motor state, the disturbing force, and a vehicle body attitude. The current motor state includes at least a present motor current.

Optionally, to determine target voltage information of a motor of the vehicle door according to the operating mode, the disturbing force, the current vehicle door state, and the vehicle door operating effect the controller is further configured to determine target current information of the motor of the vehicle door according to the operating mode, the disturbing force, the current vehicle door state, and the vehicle door operating effect. Also, to determine the target voltage information of a motor of the vehicle door according to the operating mode, the disturbing force, the current vehicle door state, and the vehicle door operating effect, the controller is also configured to determine the target voltage information according to the target current information.

Optionally, to determine target current information of the motor of the vehicle door according to the operating mode, the disturbing force, the current vehicle door state, and the vehicle door operating effect, the controller is further configured to determine a target suspending position when determining that the operating mode is the suspending mode. The controller is also configured to determine a suspending manner of the vehicle door according to the current vehicle door state, where the suspending manner includes emergency suspension and smooth suspension. In addition, determining an operation trajectory of the vehicle door according to the target suspending position and the suspending manner. In addition, to determine target current information of the motor of the vehicle door according to the operating mode, the disturbing force, the current vehicle door state, and the vehicle door operating effect the controller is also configured to determine a target speed of the motor according to the operation trajectory of the vehicle door, the disturbing force, the current vehicle door state, and the vehicle door operating effect. The controller is additionally configured to determine the target current information according to the target speed and the present motor current.

Optionally, to determine the target current information according to the target speed and the present motor current, the controller is configured to perform fuzzification and PI control on the target speed and the present motor current, to determine the target current information.

Optionally, to perform fuzzification and PI control on the target speed and the present motor current, to determine the target current information includes obtaining a target acceleration according to the target speed, the controller is further configured to perform fuzzification on the target speed and the target acceleration, to obtain a proportional parameter and an integral parameter. The controller is also configured to perform PI control on the target speed, the proportional parameter, the integral parameter, and the present motor current, to determine the target current information.

Optionally, the controller is further configured to determine whether the operating mode is the electric mode. The controller is also configured to determine whether the vehicle door is close to the target suspending position according to the current vehicle door state. In addition, the controller is configured to determine whether the current vehicle door state is that an obstacle exists near the vehicle door. The controller controls the operating mode of the vehicle door to become the suspending mode, and controls the vehicle door to suspend at the target suspending position in response to determining the operating mode is the electric mode and determining that the vehicle door is close to the target suspending position according to the current vehicle door state, or determining that the current vehicle door state is that the obstacle exists near the vehicle door.

Optionally, to determining target current information of the motor of the vehicle door according to the operating mode, the disturbing force, the current vehicle door state, and the vehicle door operating effect, the controller is further configured to determine an assist parameter when determining that the operating mode is the assist mode. In addition, the controller is configured to determine the target current information of the motor of the vehicle door according to the assist parameter, the disturbing force, the current vehicle door state, and the vehicle door operating effect.

Optionally, to determine target current information of the motor of the vehicle door according to the operating mode, the disturbing force, the current vehicle door state, and the vehicle door operating effect, the controller is further configured to plan the operation trajectory of the vehicle door when determining that the operating mode is the electric mode. The controller is also configured to determine a target position and a target speed of the vehicle door according to the operation trajectory. To determine target current information of the motor of the vehicle door according to the operating mode, the disturbing force, the current vehicle door state, and the vehicle door operating effect includes planning the operation trajectory of the vehicle door when determining that the operating mode is the electric mode, the controller may be configured to determine the target current information of the motor of the vehicle door according to the target position, the target speed, the current motor state, the disturbing force, the current vehicle door state, and the vehicle door operating effect.

Optionally, to determine the target voltage information according to the target current information, the controller is further configured to determine DC voltage information according to the target current information. The controller is also configured to transform the DC voltage information to space AC voltage information. In addition, the controller is configured to transform the space AC voltage information to SVPWM information. To determine the target voltage information according to the target current information the controller can also be configured to determine the target voltage information according to the SVPWM information.

Optionally, the controller is a variable frequency controller.

In the present invention, the disturbing force on the vehicle door is calibrated before delivery of the vehicle, so that the controller may determine, according to the input instruction, whether the operating mode of the vehicle door during the operation is the assist mode or the electric mode. If the controller determines that the current operating mode is the electric mode, and determines that the vehicle door is close to the target suspending position according to the current vehicle door state, or the current vehicle door state is that an obstacle exists near the vehicle door, the controller may determine that the operating mode of the vehicle door during the operation is the suspending mode, and may determine the vehicle door operating effect after determining the operating mode. The controller may determine the target speed of the motor of the vehicle door according to the operating mode of the vehicle door during the operation, the disturbing force, the current vehicle door state, and the operation effect of the vehicle door, and then determine the target voltage information of the motor according to the target speed of the motor, so as to control the motor. In this way, the motor can drive the vehicle door to operate according to the operating mode. According to the vehicle door operating effect, the current vehicle door state, and the disturbing force, the vehicle door can adaptively operate without relying on data of a sensor, so that the suspending effect of the vehicle door can be ensured, and accurate control of the vehicle door can be realized. Controlling the operation of the motor through the target voltage information can realize accurate control of the operation of the electric conventional door, so that a vehicle door control error caused by a torque characteristic difference between different actuating components of vehicle doors can be avoided. The present invention resolves the errors of the suspending position and the assist effect of the conventional door caused by recognizing the disturbing force on the vehicle door during the operation of the vehicle door and then establishing a mathematical model to determine the torque of the motor. The torque of the motor may be determined according to the vehicle door operating effect and the disturbing force calibrated before delivery, so as to determine the target voltage information, which achieves self-adaptation, and achieves accurate control of operation of the electric conventional door.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart of a vehicle door control method according to an embodiment of the present invention.

FIG. 2 is a flowchart of another vehicle door control method according to an embodiment of the present invention.

FIG. 3 is a schematic diagram of a disturbing force on a vehicle door according to an embodiment.

FIG. 4 is a schematic diagram of another disturbing force on the vehicle door according to an embodiment.

FIG. 5 is a flowchart of still another vehicle door control method according to an embodiment of the present invention.

FIG. 6 is a flowchart of a method for determining target voltage information included in S350 in FIG. 5 according to an embodiment of the present invention.

FIG. 7 is a principle diagram of the method for determining the target voltage information corresponding to FIG. 6 according to an embodiment of the present invention.

FIG. 8 is a schematic diagram of space vector pulse width modulation (SVPWM) information according to an embodiment of the present invention.

FIG. 9 is a flowchart of yet another vehicle door control method according to an embodiment of the present invention.

FIG. 10 is a graph of adapting to the disturbing force during suspension of the vehicle door according to an embodiment of the present invention.

FIG. 11 is a flowchart of still yet another vehicle door control method according to an embodiment of the present invention.

FIG. 12 is a flowchart of a method for determining target current information included in S590 in FIG. 11 according to an embodiment of the present invention.

FIG. 13 is a principle diagram of the method for determining the target current information corresponding to FIG. 12 according to an embodiment of the present invention.

FIG. 14 is a flowchart of a further vehicle door control method according to an embodiment of the present invention.

FIG. 15 is a flowchart of a still further vehicle door control method according to an embodiment of the present invention.

FIG. 16 is a schematic diagram of a vehicle door operation trajectory according to an embodiment of the present invention.

FIG. 17 is a schematic diagram of a vehicle door control system according to an embodiment of the present invention.

Corresponding reference numerals indicate corresponding parts throughout the several views of the drawings.

### DETAILED DESCRIPTION

The present invention is further described in detail below with reference to accompanying drawings and embodiments. It may be understood that specific embodiments described herein are only used to explain the present invention, but not to limit the present invention. In addition, it should be further noted that, for ease of description, the accompanying drawings only show parts relevant to this invention rather than the entire structure. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

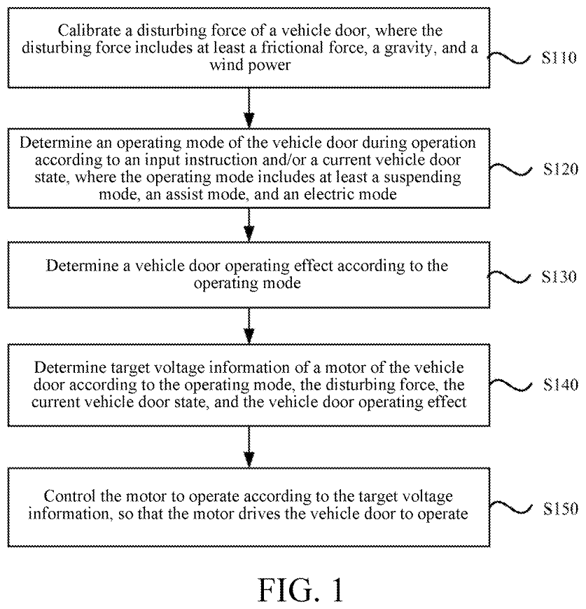

FIG. 1 is a flowchart of a vehicle door control method according to an embodiment of the present invention. Referring to FIG. 1, the vehicle door control method includes the step of S110 calibrating a disturbing force of a vehicle door, where the disturbing force includes at least a frictional force, a gravity, and a wind power. In more detail, the vehicle door is, for example, a conventional door of a vehicle. Before delivery of the vehicle, a disturbing force on the vehicle door is calibrated in different scenarios. Each force on the vehicle door in different scenarios may be detected through a sensor, and then a value of the disturbing force on the vehicle door is determined through modeling. The disturbing force is, for example, a combination of the frictional force, the gravity, and the wind power. The disturbing force may further include other forces, which is not limited herein.

For example, modeling is performed for different frictional force, gravity, and wind power scenarios to calibrate the disturbing force of the vehicle door before delivery. Therefore, the disturbing force on the vehicle door no longer needs to be detected during operation of the vehicle, which can reduce a quantity of sensors to be arranged on the vehicle, thereby reducing the costs. Calibrating the disturbing force in different scenarios help adapt to different operation conditions and terrains during control of the vehicle. In addition, detecting the force on the vehicle door during the operation of the vehicle will encounter relatively much interference and cannot resist the interference effectively, which results in a failure in accurately determining the disturbing force on the vehicle door. As a result, a suspending effect and an assist effect are affected, the reliability is poor, and the complexity is high. Therefore, calibrating the disturbing force on the vehicle door before delivery of the vehicle can accurately determine the disturbing force on the vehicle door, thereby ensuring the suspending effect and the assist effect and improving the control accuracy and reliability.

Continuing to refer to FIG. 1, the vehicle door control method also includes the step of S120 determining an operating mode of the vehicle door during operation according to an input instruction and/or a current vehicle door state, where the operating mode includes at least a suspending mode, an assist mode, and an electric mode. In m more detail, the vehicle door is, for example, the conventional door of the vehicle, the operation of the vehicle door means opening or closing of the vehicle door, and the operating mode of the vehicle door during the operation includes the suspending mode, the assist mode, and the electric mode. The assist mode means assisting a user when the user is opening or closing the vehicle door, so that the user can open or close the vehicle door easily. The electric mode means that the vehicle door automatically opens or closes when the user presses an opening button or a closing button through a key and the like. The suspending mode means controlling the vehicle door to suspend at a target suspending position. For example, in the electric mode, if the vehicle door is close to the target suspending position, the controller controls the operating mode of the vehicle door to become the suspending mode, so as to control the vehicle door to suspend at the target suspending position.

The user may input an instruction to select the operating mode of the vehicle door as the assist mode or the electric mode, and the controller may determine that the operating mode of the vehicle door is the assist mode or the electric mode according to the input instruction. In addition, if the controller determines that the current operating mode is the electric mode, and determines that the vehicle door is close to the target suspending position according to the current vehicle door state, or determines that the current vehicle door state is that an obstacle exists near the vehicle door, the controller controls the operating mode of the vehicle door to become the suspending mode, and controls the vehicle door to suspend at the target suspending position, so that the controller can determine that the vehicle door enters the suspending mode.

Additionally, according to the current vehicle door state, it may be determined whether a force is acting on the vehicle door, and a current operating direction of the vehicle door may be determined, that is, whether a person is opening or closing the vehicle door may be determined. If the force is acting on the vehicle door, and the operating direction of the vehicle door is an opening direction, the controller controls the vehicle door to enter the electric mode and automatically opens the door. If the force is acting on the vehicle door and the operating direction of the vehicle door is a closing direction, the controller controls the vehicle door to enter the electric mode and automatically closes the door. In this way, an opening motion and a closing motion can be recognized, and a corresponding operating mode is performed according to the opening motion and the closing motion.

The vehicle door control method also includes the step of S130 determining a vehicle door operating effect according to the operating mode. More precisely, the vehicle door operating effect is a target operating effect. When the operating mode of the vehicle door is the suspending mode, the vehicle door operating effect is determined, that is, the suspending effect of the vehicle door is determined. For example, the suspending effect may include the target suspending position. When the operating mode of the vehicle door is the assist mode, the vehicle door operating effect is determined, that is, the assist effect of the vehicle door is determined. The assist effect may include, for example, easy door opening and ultra easy door opening. The easy door opening means that the user can open or close the vehicle door with a relatively small force, and the easy door opening means that the user can open or close the vehicle door with a very small force.

The vehicle door control method additionally includes the step of S140 determining target voltage information of a motor of the vehicle door according to the operating mode, the disturbing force, the current vehicle door state, and the vehicle door operating effect. Specifically, the controller may determine a target speed of the motor of the vehicle door according to the operating mode of the vehicle door, the disturbing force, the current vehicle door state, and the vehicle door operating effect. For example, when the operating mode of the vehicle door is the assist mode, a required assist force may be determined according to the assist effect selected by the user and the disturbing force to be overcome, the target speed of the motor may be calculated according to the force, and then the target voltage information of the motor may be determined according to the target speed of the motor, so as to control the motor, so that the motor can drive the vehicle door to operate according to the operating mode. In addition, the vehicle door can be caused to adaptively operate according to the vehicle door operating effect, the current vehicle door state, and the disturbing force. For example, when the vehicle door operating effect is the easy door opening, it may be determined according to the current vehicle door state that the operating speed of the vehicle door does not satisfy the effect of the easy door opening. That is to say, the current operation of the vehicle door does not satisfy the vehicle door operating effect. In this case, the target voltage information of the motor may be adjusted according to the vehicle door operating effect and the disturbing force, so that the vehicle door can adaptively operate. Moreover, adjusting the target voltage information according to the vehicle door operating effect can ensure a relatively desirable vehicle door operating effect, so that the user does not need to monitor an acting point of a hand of the user on the vehicle door, thereby reducing errors caused by acting on different positions on the vehicle door by the hand. For example, when the operating mode is the suspending mode, during control of the vehicle door to suspend at the target position, if the wind becomes stronger and the vehicle door moves, it may be determined according to the current vehicle door state that the vehicle door does not satisfy the vehicle door operating effect. In this case, the target voltage information may be adjusted to cause the vehicle door to suspend at the target position. Therefore, the suspending effect of the vehicle door can be ensured without a need to detect the wind power on the vehicle door. In addition, since it is difficult to effectively acquire a wind status, control according to the wind power does not lead to a relatively desirable suspending effect, and a control error increases as the wind increases. In the technical solution in this embodiment, the target voltage information can be adjusted according to the vehicle door operating effect and the current vehicle door state without relying on data of the sensor, which can ensure the suspending effect of the vehicle door and realize the accurate control of the vehicle door.

In addition, the vehicle door control method includes the step of S150 controlling the motor to operate according to the target voltage information, so that the motor drives the vehicle door to operate. The motor is, for example, a brushless direct current motor (BLDCM) or a permanent magnetic synchronous machine (PMSM). The controller is, for example, a variable frequency controller. The variable frequency controller controls the operation of the motor according to the target voltage information, and the motor drives the vehicle door to operate, so as to realize the control of the vehicle door. Controlling the operation of the motor by using the target voltage information can accurately control the operation of the electric conventional door, which avoids an error in the control of the vehicle door caused by the torque characteristic difference of different actuating components of the vehicle door. Therefore, a problem regarding errors in the suspending position and the assist effect of the conventional door caused by direct control of an output torque of the motor is resolved. In addition, the BLDCM and the PMSM have relatively long service lives and relatively high efficiency, so that a vehicle door control system has a relatively long service life, and the control efficiency of the vehicle door is improved.

The target voltage information includes a space vector voltage, so that the operation of the motor can be controlled more accurately, thereby realizing the accurate control of the vehicle door.

Since the target voltage information is determined and the motor is controlled to operate according to the target voltage information, when the motor rotates by a relatively small angle, the target voltage information may be adjusted a plurality of times, thus realizing control from a microscopic perspective.

In the technical solution in this embodiment, the disturbing force on the vehicle door is calibrated before delivery of the vehicle, so that the controller may determine, according to the input instruction, whether the operating mode of the vehicle door during the operation is the assist mode or the electric mode. If the controller determines that the current operating mode is the electric mode, and determines that the vehicle door is close to the target suspending position according to the current vehicle door state, or the current vehicle door state is that an obstacle exists near the vehicle door, the controller may determine that the operating mode of the vehicle door during the operation is the suspending mode, and may determine the vehicle door operating effect after determining the operating mode. The controller may determine the target speed of the motor of the vehicle door according to the operating mode of the vehicle door during the operation, the disturbing force, the current vehicle door state, and the vehicle door operating effect, and then determine the target voltage information of the motor according to the target speed of the motor, so as to control the motor. In this way, the motor can drive the vehicle door to operate according to the operating mode. According to the vehicle door operating effect, the current vehicle door state, and the disturbing force, the vehicle door can adaptively operate without relying on data of a sensor, so that the suspending effect of the vehicle door can be ensured, and accurate control of the vehicle door can be realized. Controlling the operation of the motor through the target voltage information can realize accurate control of the operation of the electric conventional door, so that a vehicle door control error caused by a torque characteristic difference between different actuating components of vehicle doors can be avoided. The technical solution in this embodiment resolves the errors of the suspending position and the assist effect of the conventional door caused by recognizing the disturbing force on the vehicle door during the operation of the vehicle door and then establishing a mathematical model to determine the torque of the motor. The torque of the motor may be determined according to the vehicle door operating effect and the disturbing force calibrated before delivery, so as to determine the target voltage information, which achieves self-adaptation, and achieves accurate control of operation of the electric conventional door.

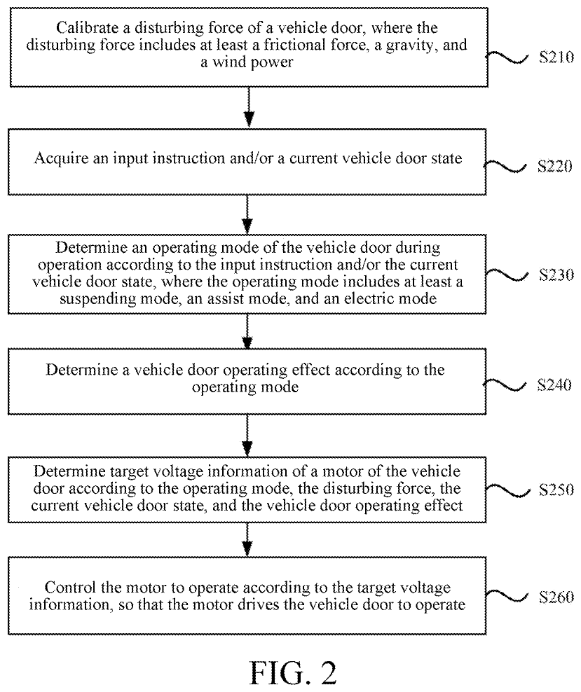

FIG. 2 is a flowchart of another vehicle door control method according to an embodiment of the present invention. Optionally, referring to FIG. 2, the vehicle door control method includes the step of S210 calibrating a disturbing force of a vehicle door, where the disturbing force includes at least a frictional force, a gravity, and a wind power.

The method additionally includes the step of S220 acquiring an input instruction and/or a current vehicle door state. The acquisition of the current vehicle door state includes determining the current vehicle door state according to a current motor state, the disturbing force, and a vehicle body attitude, where the current motor state includes at least a present motor current. In more detail, when determining an operating mode of the vehicle door, the controller first acquires the input instruction and/or the current vehicle door state. A user may input an instruction through a key, a button, or the like. The acquisition of the input instruction is acquisition of the instruction inputted through the key or the button. Upon acquisition of the input instruction, the controller may determine, according to the input instruction, whether the operating mode of the vehicle door is an assist mode or an electric mode.

The controller may determine a rotor position of a motor according to parameters such as the present motor current, so as to determine a current position of the vehicle door, determine a current external force on the vehicle door according to the disturbing force, and may further determine the current vehicle door state according to the vehicle body attitude, so as to analyze the current external force on the vehicle door, so that the vehicle door can adapt to conditions at different position. The vehicle body attitude includes at least a tilt angle and a pitch angle of a vehicle body. The vehicle body attitude may be acquired from a vehicle bus or a sensor value. The sensor value may further include a foreign object detection value. It may be determined according to the foreign object detection value whether an obstacle exists near the vehicle door, so as to determine the current vehicle door state. The controller may determine whether the vehicle door enters the suspending mode according to the current vehicle door state. For example, if the current vehicle door state is that the vehicle door is close to a target suspending position or that an obstacle exists near the vehicle door, the controller may determine that the operating mode of the vehicle door becomes the suspending mode. Acquiring the vehicle body attitude from the vehicle bus can reduce sensors required to be arranged, thereby reducing the costs.

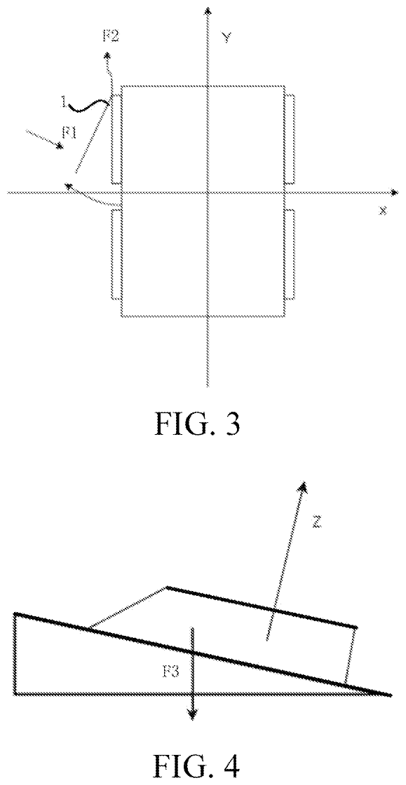

The disturbing force includes, for example, the wind power, the frictional force, and the gravity. FIG. 3 is a schematic diagram of a disturbing force on a vehicle door according to an embodiment. Referring to FIG. 3, a disturbing force F1 is a wind force on a vehicle door 1, and a disturbing force F2 is a frictional force on the vehicle door 1. FIG. 4 is a schematic diagram of another disturbing force on the vehicle door according to an embodiment. Referring to FIG. 4, a case where a vehicle is on a slope is shown, and a disturbing force F3 is a gravity on the vehicle door 1. In this way, analysis of the disturbing force on the vehicle door and force analysis of the vehicle door at different positions are realized, which facilitates control of the vehicle door in different operating conditions. The disturbing force on the vehicle door may further include other forces, which is not limited herein. The sensor value is acquired by a sensor. The sensor is, for example, a gyroscope. The gyroscope may detect a tilt angle of the vehicle body, so as to determine the tilt angle of the vehicle door, thereby determining the current vehicle door state. It should be noted that the sensor is optionally arranged, and is not necessarily arranged.

Optionally, referring back to FIG. 2, the vehicle door control method also includes the step of S230 determining an operating mode of the vehicle door during operation according to the input instruction and/or the current vehicle door state, where the operating mode includes at least a suspending mode, an assist mode, and an electric mode. The method continues with the step of S240 determining a vehicle door operating effect according to the operating mode. Next, S250 determining target voltage information of a motor of the vehicle door according to the operating mode, the disturbing force, the current vehicle door state, and the vehicle door operating effect. The method can additionally include the step of S260 controlling the motor to operate according to the target voltage information, so that the motor drives the vehicle door to operate.

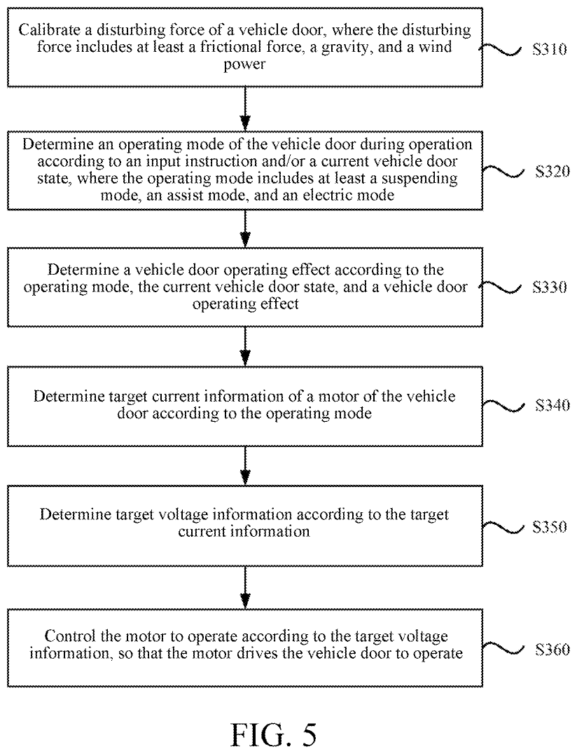

FIG. 5 is a flowchart of still another vehicle door control method according to an embodiment of the present invention. Optionally, referring to FIG. 5, the vehicle door control method includes the step of S310 calibrating a disturbing force of a vehicle door, where the disturbing force includes at least a frictional force, a gravity, and a wind power. The method proceeds with the step of S320 determining an operating mode of the vehicle door during operation according to an input instruction and/or a current vehicle door state, where the operating mode includes at least a suspending mode, an assist mode, and an electric mode. The method continues by S330 determining a vehicle door operating effect according to the operating mode.

The method also includes the step of S340 determining target current information of a motor of the vehicle door according to the operating mode, the disturbing force, the current vehicle door state, and the vehicle door operating effect. More specifically, a controller may determine a target speed of the motor of the vehicle door according to the operating mode of the vehicle door, the disturbing force, the current vehicle door state, and the vehicle door operating effect. For example, when the operating mode of the vehicle door is the assist mode, a required assist force may be determined according to the assist effect selected by a user the target speed of the motor may be calculated according to the force, and the target current information required for operation of the motor may be determined according to the target speed of the motor

In addition, the current vehicle door state may further include whether the vehicle door is subjected to an external force, or whether there is a person at the vehicle door. When the vehicle door is subjected to the external force, it indicates that a person touches the vehicle door. In this case, the target current information of the motor of the vehicle door is determined as zero, and the vehicle door is controlled to stop operating, so as to avoid clamping the user, thereby realizing an anti-clamping effect.

Moreover, the target current information may be adjusted according to the current vehicle door state. If the current vehicle door state is that the vehicle door is operating fast, the target current information may be adjusted, to reduce a speed of the vehicle door to a relatively small speed, so that the speed of the vehicle door is less than a preset speed, and an acceleration of the vehicle door is less than a preset acceleration, which avoids slamming of the vehicle door, thereby realizing an anti-slamming effect.

Still referring to FIG. 5, the vehicle door control method includes the step of S350 determining target voltage information according to the target current information. Specifically, a controller may transform the target current information into space vector pulse width modulation (SVPWM) information. The target voltage information required for operation of the motor may be determined according to the SVPWM information. The vehicle door control method can also include the step of S360 controlling the motor to operate according to the target voltage information, so that the motor drives the vehicle door to operate.

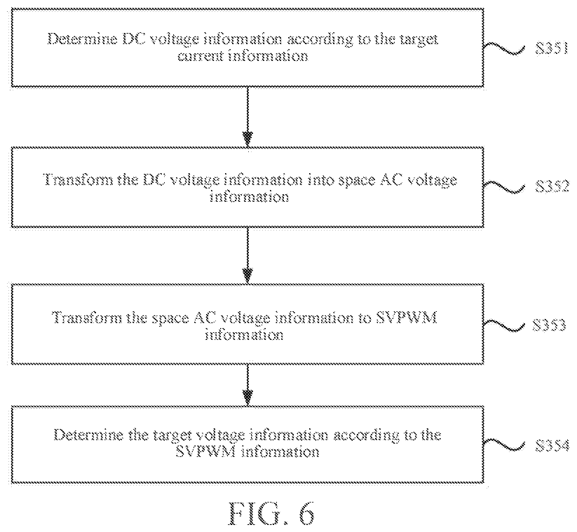

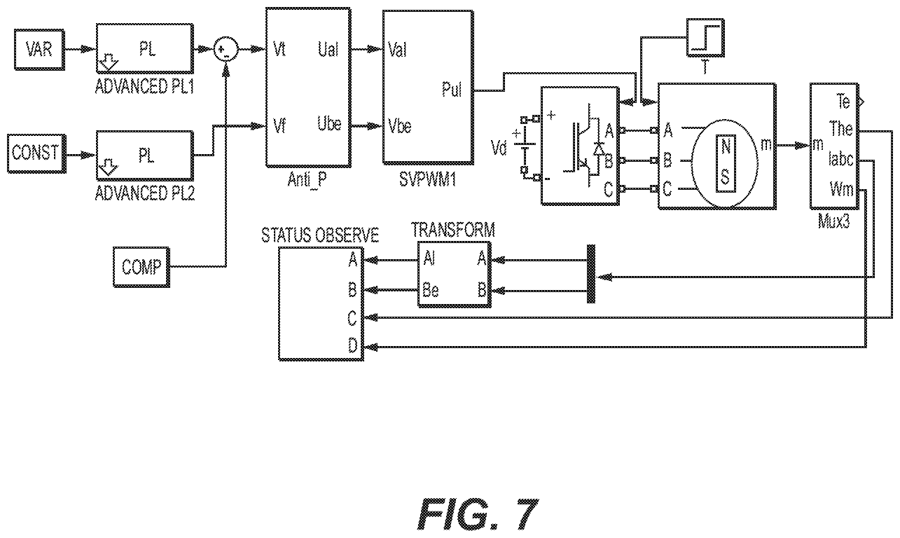

Based on the above technical solution, FIG. 6 is a flowchart of a method for determining the target voltage information included in S350 in FIG. 5 according to an embodiment of the present invention, and FIG. 7 is a schematic diagram of components or functional blocks of the controller for determining the target voltage information corresponding to FIG. 6 according to an embodiment of the present invention. Optionally, referring to FIG. 6 and FIG. 7, the step of S350 determining the target voltage information according to the target current information includes the following step S351 determining DC voltage information according to the target current information. With reference to FIG. 7 specifically, the calculated target current information var is used as a first input, and a calibrated current const calibrated during delivery of the motor is used as a second input. The target current information var may be transformed to first DC voltage information Vt through proportional-integral (PI) control. A compensation comp may be inputted during the PI control. Through the PI control, more accurate first DC voltage information Vt can be obtained. The calibrated current const may be transformed to second DC voltage information Vf through the PI control.

Referring to FIG. 6 and FIG. 7, the step of S350 determining the target voltage information according to the target current information can also include the step of S352 transforming the DC voltage information into space AC voltage information. Specifically, referring back to FIG. 7, the first DC voltage information Vt is transformed to first space AC voltage information, and the second DC voltage information Vf is transformed to the second space AC voltage information Ub. In this way, the DC voltage information is transformed to the space AC voltage information.

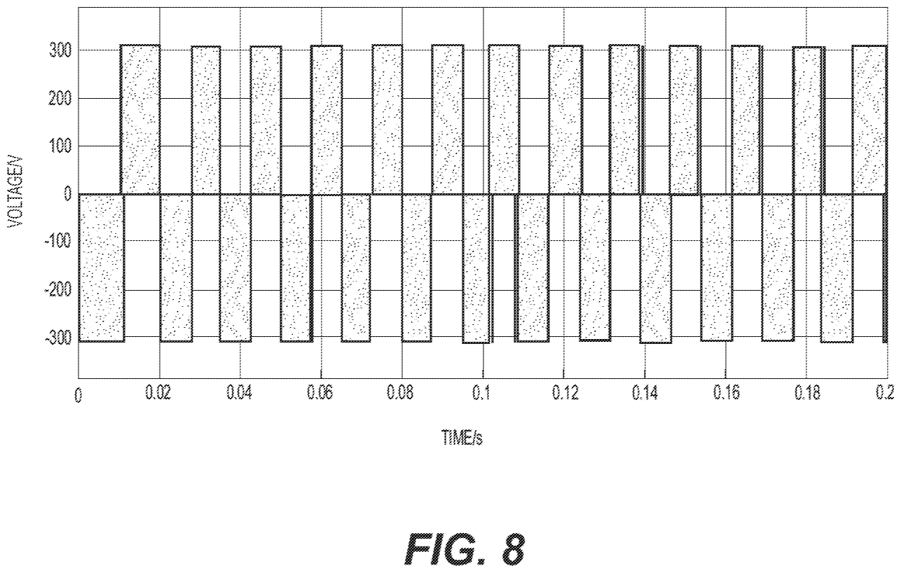

In addition, the step of S350 determining the target voltage information according to the target current information can also include the step of S353 transforming the space AC voltage information to space vector pulse width modulation (SVPWM) information. In more detail, as shown in FIG. 7, SVPWM information corresponding to a target frequency may be obtained according to first space AC voltage information Ual and second space AC voltage information Ube. FIG. 8 is a schematic diagram of SVPWM information according to an embodiment of the present invention. As shown in FIG. 8, a frequency of the SVPWM information may be controlled to adjust the voltage of the motor, thus realizing frequency control.

The step of S350 determining the target voltage information according to the target current information can also include the step of S354 determining the target voltage information according to the SVPWM information. In more detail, as shown in FIG. 7, an inverter of the motor may be controlled by using the SVPWM information, so that the inverter of the motor outputs the target voltage information to the motor. For example, information about target voltages of three phases A, B, and C is outputted to the motor, so that the motor can operate according to the target voltage information, thereby driving the vehicle door to operate.

After the target voltage information is determined, the target voltage information is transmitted to the motor, so that the motor operates according to the target speed. Information about the motor, such as three-phase current information labc, speed information Wm, and angle information The of the motor may be collected. In addition, the three-phase current information labc may be transformed to space current information through a transformation device Transform. Status estimation (status observe) may be performed on the motor through the space current information, the speed information Wm, and the angle information The, to obtain the current motor state.

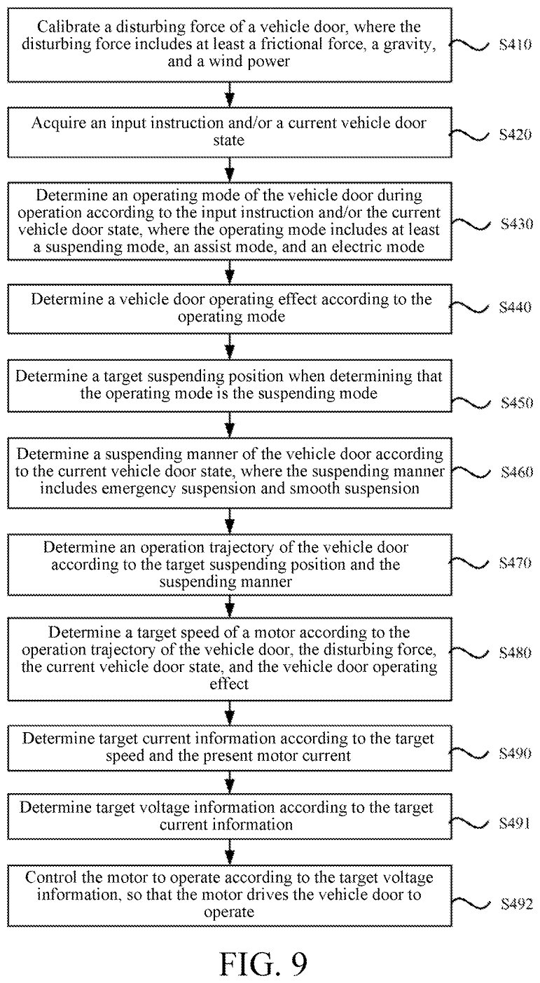

FIG. 9 is a flowchart of yet another vehicle door control method according to an embodiment of the present invention. Optionally, referring to FIG. 9, the vehicle door control method includes the step of S410 calibrating a disturbing force of a vehicle door, where the disturbing force includes at least a frictional force, a gravity, and a wind power. The method continues with the step of S420 acquiring an input instruction and/or a current vehicle door state. The acquisition of the current vehicle door state includes determining the current vehicle door state according to a current motor state, the disturbing force, and a vehicle body attitude, where the current motor state includes at least a present motor current.

Continuing to refer to FIG. 9, the vehicle door control method includes the step of S430 determining an operating mode of the vehicle door during operation according to the input instruction and/or the current vehicle door state, where the operating mode includes at least a suspending mode, an assist mode, and an electric mode. Next, S440 determining a vehicle door operating effect according to the operating mode.

The method continues with the step of S450 determining a target suspending position when determining that the operating mode is the suspending mode. In more detail, when the controller determines that the operating mode of the vehicle door during the operation is the suspending mode, the target suspending position is determined. For example, the target suspending position may be determined according to an operation trajectory of the vehicle door determined in the electric mode, or may be determined according to a target position of the vehicle door determined in the electric mode, or may be inputted by a user.

The vehicle door control method also includes the step of S460 determining a suspending manner of the vehicle door according to the current vehicle door state, where the suspending manner includes emergency suspension and smooth suspension. For example, when the controller determines that the current vehicle door state is that an obstacle exists near the vehicle door, the suspending manner of the vehicle door is determined as the emergency suspension. The speed and acceleration of the vehicle door during the emergency suspension are relatively large, so that the vehicle door can quickly reach the target suspending position. When the controller determines that the current vehicle door state is that no obstacle exists near the vehicle door, the suspending manner of the vehicle door may be determined as the smooth suspension. The speed and acceleration of the vehicle door during the smooth suspension are relatively small, so that the vehicle door can stably reach the target suspending position.

In addition, still referring to FIG. 9, the vehicle door control method includes the step of S470 determining an operation trajectory of the vehicle door according to the target suspending position and the suspending manner. Specifically, the operation trajectory of the vehicle door is, for example, stored in the controller during delivery of the vehicle. A plurality of operation trajectories of the vehicle door may be stored in the controller for selection by the controller and the user. For example, when the current vehicle door state is a vehicle door opening angle of 40°, the target suspending position is a vehicle door opening angle of 60°, and the suspending manner is the smooth suspension, since the current position of the vehicle door is relatively far from the target suspending position a vehicle door operation trajectory having a relatively small speed and a relatively small acceleration may be selected. When the current vehicle door state is a vehicle door opening angle of 55°, the target suspending position is a vehicle door opening angle of 60°, and the suspending manner is the smooth suspension, since the current position of the vehicle door is relatively close to the target suspending position a vehicle door operation trajectory having a relatively large speed and a relatively small acceleration may be selected. When the current vehicle door state is a vehicle door opening angle of 48°, the target suspending position is a vehicle door opening angle of 60°, and the suspending manner is the emergency suspension, since the current position of the vehicle door is far from the target suspending position a vehicle door operation trajectory having a relatively large speed and a relatively large acceleration may be selected. In addition, if an obstacle exists at the target suspending position, the controller may re-determine the target suspending position to prevent the vehicle door from touching the obstacle, thereby protecting the vehicle door.

The vehicle door control method can also include the step of S480 determining a target speed of a motor according to the operation trajectory of the vehicle door, the disturbing force, the current vehicle door state, and the vehicle door operating effect. In more detail, the target suspending position, the speed, the acceleration, and a jerk of the vehicle door may be determined according to the operation trajectory of the vehicle door, and an external force to be overcome during the operation of the vehicle door may be determined according to the disturbing force, a target force to be applied to the vehicle door may be determined according to the speed, the acceleration, and the disturbing force of the vehicle door, the target force may be adjusted according to the current vehicle door state and the vehicle door operating effect, and a target torque of the motor may be determined according to the target force of the vehicle door. In this way, the target speed of the motor can be determined. The target speed of the motor may be a fixed value, or may be constantly changed according to the disturbing force, so that the target speed of the motor can adapt to the disturbing force. That is to say, the target force to be applied to the vehicle door in the suspending mode is constantly changed according to the disturbing force.

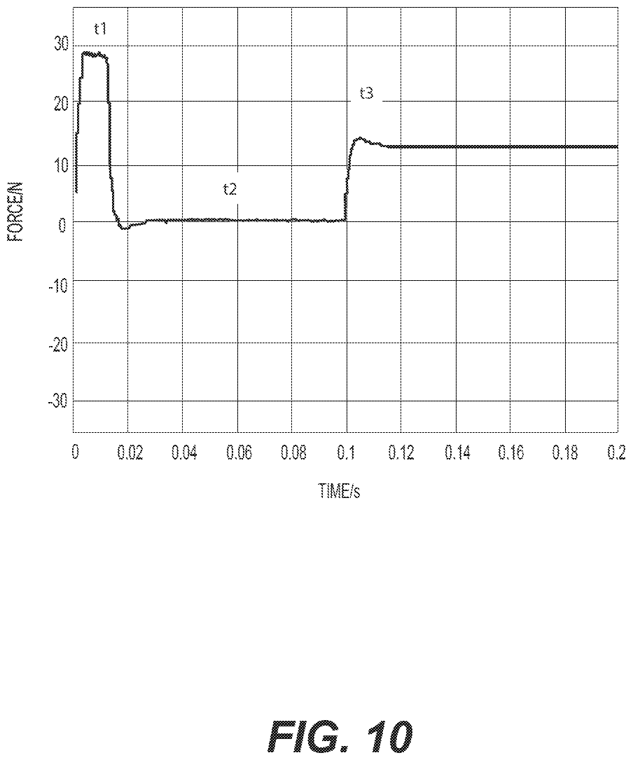

FIG. 10 is a graph of adapting to the disturbing force during suspension of the vehicle door according to an embodiment of the present invention. As shown in FIG. 10, in a first stage t1, the vehicle door has just entered the suspending mode, and the target force applied to the vehicle door is relatively large. In a second stage t2, the vehicle door reaches the target suspending position does not need to move, and the target force of the vehicle door approximates 0. In a third stage t3, the vehicle door is interfered by an external force during suspension, and the target force required for the vehicle door is equal to the external force, so that the vehicle door stably suspends. In this way, adaption to the disturbing force is realized during the suspension, and the accurate control of the vehicle door is realized.

Referring back to FIG. 9, the vehicle door control method also includes the step of S490 determining target current information according to the target speed and the present motor current. More specifically, during determining of the target current information according to the target speed, the present motor current may be used as a negative feedback, so that the controller can determine the target current information more accurately, which reduces a difference between the present motor current and the target current information, thereby controlling the operation of the motor operation more effectively, and controlling the suspending position of the electric conventional door more accurately. Using the present motor current as the feedback can realize adjustment of a difference value, so that an actual current of the motor can conform to the target current information, thereby realizing the accurate control of the motor. The vehicle door control method also includes the step of S491 determining target voltage information according to the target current information. The vehicle door control method can additionally include the step of S492 controlling the motor to operate according to the target voltage information, so that the motor drives the vehicle door to operate.

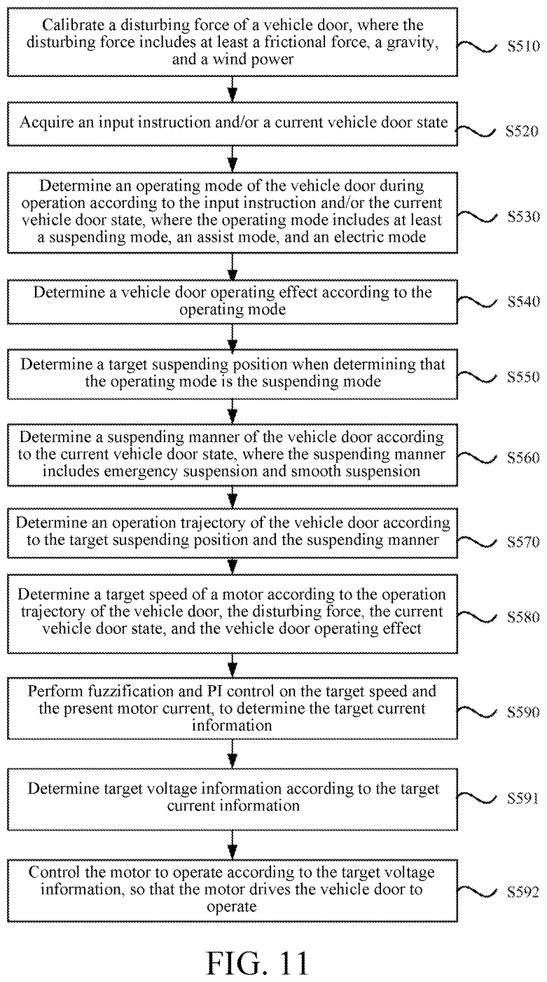

FIG. 11 is a flowchart of still yet another vehicle door control method according to an embodiment of the present invention. Optionally, referring to FIG. 11, the vehicle door control method includes the step of S510 calibrating a disturbing force of a vehicle door, where the disturbing force includes at least a frictional force, a gravity, and a wind power. The method also includes the step of S520 acquiring an input instruction and/or a current vehicle door state. The acquisition of the current vehicle door state includes determining the current vehicle door state according to a current motor state, the disturbing force, and a vehicle body attitude, where the current motor state includes at least a present motor current.

The method continues with the step of S530 determining an operating mode of the vehicle door during operation according to the input instruction and/or the current vehicle door state, where the operating mode includes at least a suspending mode, an assist mode, and an electric mode. The next step of the method is S540 determining a vehicle door operating effect according to the operating mode. The method additionally includes the step of S550 determining a target suspending position when determining that the operating mode is the suspending mode. The method proceeds with the step of S560: Determine a suspending manner of the vehicle door according to the current vehicle door state, where the suspending manner includes emergency suspension and smooth suspension. In addition, the method includes the step of S570 determining an operation trajectory of the vehicle door according to the target suspending position and the suspending manner. The method proceeds by S580 determining a target speed of a motor according to the operation trajectory of the vehicle door, the disturbing force, the current vehicle door state, and the vehicle door operating effect.

The method continues with the step of S590 performing fuzzification and proportional-integral (PI) control on the target speed and the present motor current, to determine target current information. Specifically, the fuzzification or fuzzy processing is performed on the target speed through a fuzzy control system. Fuzzification may be first performed on the target speed and the acceleration, then calculation is performed according to a fuzzy algorithm, and then defuzzification is performed, a proportional parameter and an integral parameter are outputted, and PI control is performed on the target speed according to the proportional parameter and the integral parameter. During the PI control, the present motor current is used as a negative feedback input to determine the target current information, which can reduce an error of the target current information, thereby controlling the operation of the motor more accurately and realizing the accurate control of the electric conventional door. The next step of the method is S591 determining target voltage information according to the target current information. The method also includes the step of S592 controlling the motor to operate according to the target voltage information, so that the motor drives the vehicle door to operate.

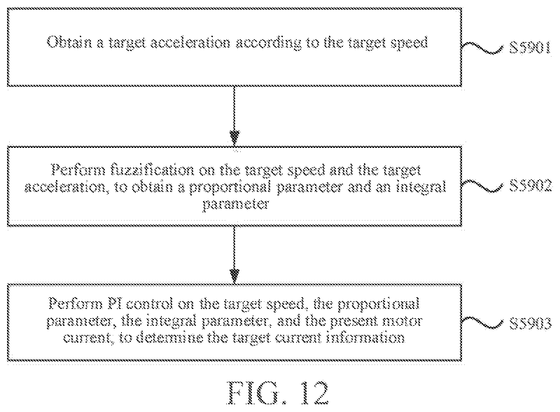

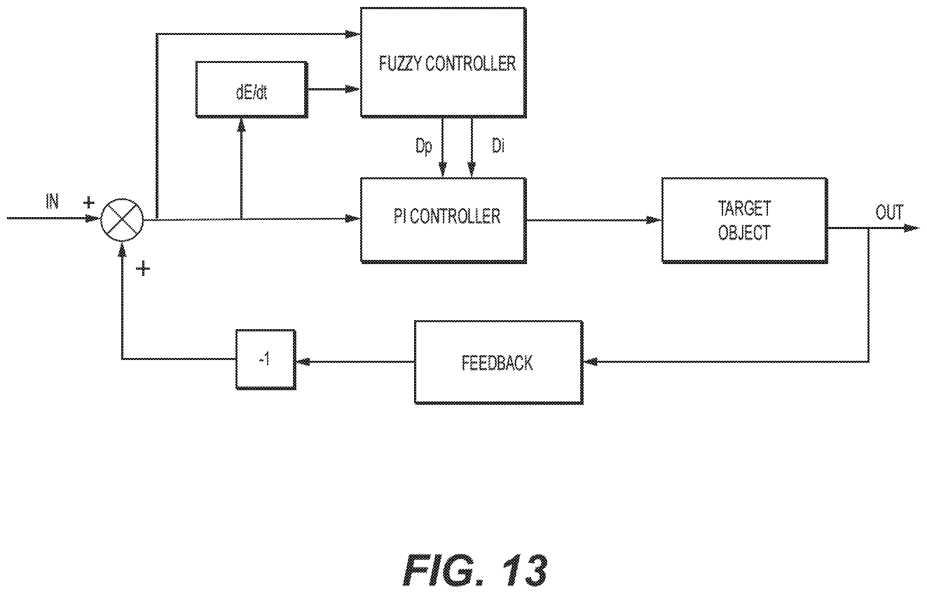

Based on the above technical solution, FIG. 12 is a flowchart of a method for determining the target current information included in step S590 in FIG. 11 according to an embodiment of the present invention, and FIG. 13 is a schematic diagram of components or functional blocks of the controller for determining the target current information corresponding to FIG. 12 according to an embodiment of the present invention. Optionally, referring to FIG. 12 and FIG. 13, the step of S590 performing the fuzzification or fuzzy processing and the PI control on the target speed and the present motor current, to determine the target current information includes the step of S5901 obtaining a target acceleration according to the target speed. Specifically, with reference back to FIG. 13, the target speed is used as an input IN, and dE/dt is used to differentiate the target speed to obtain a target acceleration corresponding to the target speed. Then the target speed and the target acceleration are inputted into the fuzzy controller for the fuzzification.

The step of S590 performing the fuzzification and the PI control on the target speed and the present motor current, to determine the target current information also may include the step of S5902 performing fuzzification on the target speed and the target acceleration, to obtain a proportional parameter and an integral parameter. In more detail, referring back to FIG. 13, fuzzification is performed on the target speed and the target acceleration through the fuzzy controller. Fuzzification may be first performed on the target speed and the acceleration, then calculation is performed according to a fuzzy algorithm, and then defuzzification is performed, and a proportional parameter Dp and an integral parameter Di are outputted.

The step of S590 performing the fuzzification and the PI control on the target speed and the present motor current, to determine the target current information also can include the step of S5903 performing PI control on the target speed, the proportional parameter, the integral parameter, and the present motor current, to determine the target current information. Specifically, as shown in FIG. 13, the PI control is performed on the target speed, the proportional parameter, and the integral parameter. The PI control may be realized by a PI controller. The target current information is outputted to a target object, where the target object is the motor, and then the present motor current is used as a negative feedback and is inputted to the PI controller, which can reduce an error of the outputted target current information, thereby determining the target current information more accurately.

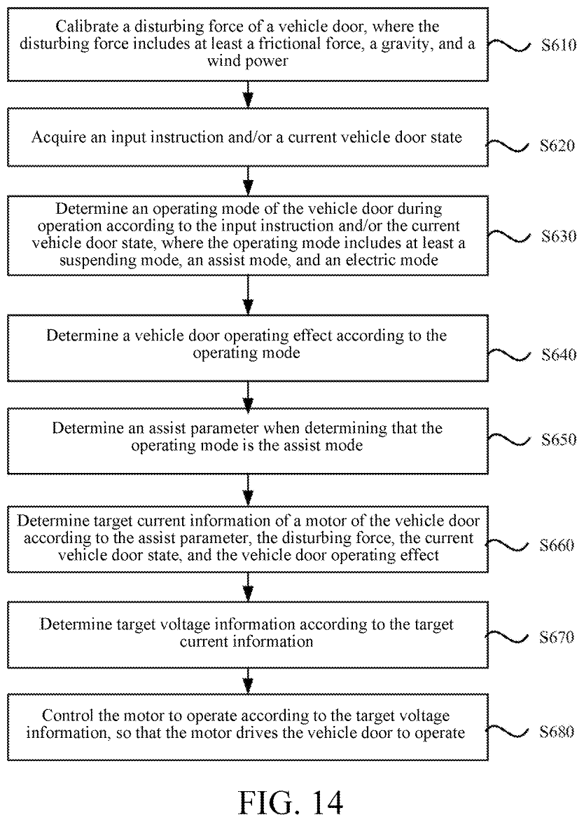

FIG. 14 is a flowchart of still yet another vehicle door control method according to an embodiment of the present invention. Optionally, referring to FIG. 14, the vehicle door control method includes the step of S610 calibrating a disturbing force of a vehicle door, where the disturbing force includes at least a frictional force, a gravity, and a wind power. The method continues with the step of S620 acquiring an input instruction and/or a current vehicle door state. The acquisition of the current vehicle door state may include determining the current vehicle door state according to a current motor state, the disturbing force, and a vehicle body attitude, where the current motor state includes at least a present motor current. The next step of the method is S630: Determine an operating mode of the vehicle door during operation according to the input instruction and/or the current vehicle door state, where the operating mode includes at least a suspending mode, an assist mode, and an electric mode. The method continues by S640 determining a vehicle door operating effect according to the operating mode.

The method proceeds with the step of S650 determining an assist parameter when determining that the operating mode is the assist mode. More specifically, when it is determined that the operating mode is the assist mode, an assist effect may be determined first. The assist effect is, for example, easy vehicle door opening or closing, or may be ultra easy vehicle door opening or closing. The assist effect may be selected by the user. When the user does not select the assist effect, assistance may be provided according to a default assist effect. The assist parameter may be determined according to the assist effect, and a required assist force may be determined.

The method additionally includes the step of S660 determining target current information of a motor of the vehicle door according to the assist parameter, the disturbing force, the current vehicle door state, and the vehicle door operating effect. In more detail, a current position of the vehicle door may be determined according to the current vehicle door state, a target torque of the motor may be determined according to the assist parameter, the disturbing force, and the current position of the vehicle door, and it is determined whether the current vehicle door state satisfies the vehicle door operating effect. If the current vehicle door state does not satisfy the vehicle door operating effect, the target torque may be adjusted according to the vehicle door operating effect. The target current information of the motor may be determined according to the target torque of the motor, which realizes correction of the target current information by using the vehicle door operating effect. In this way, the error of the target current information can be reduced, thereby realizing the vehicle door operating effect more accurately, and realizing the accurate control of the vehicle door.

For example, when the operating mode of the vehicle door is the assist mode, the vehicle door operating effect is the assist effect. The assist effect is, for example, continuously variable speed assist, that is, the speed slowly increases during the operation of the vehicle door. The assist effect may be continuously variable force assist, that is, a force provided for the user during the operation of the vehicle door slowly increases, so that more effective assistance can be achieved, and a damage to the user and the vehicle door caused by great changes during the assistance can be avoided.

The method continues by S670 determining target voltage information according to the target current information. The method also includes the step of S680: Control the motor to operate according to the target voltage information, so that the motor drives the vehicle door to operate.

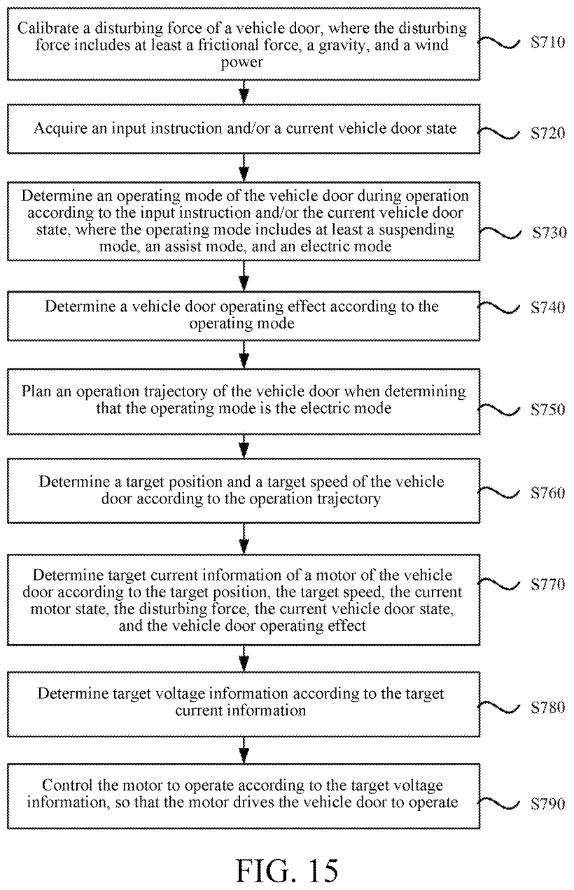

FIG. 15 is a flowchart of still yet another vehicle door control method according to an embodiment of the present invention. Optionally, referring to FIG. 15, the vehicle door control method includes the step of S710 calibrating a disturbing force of a vehicle door, where the disturbing force includes at least a frictional force, a gravity, and a wind power. The next step of the method is S720: Acquire an input instruction and/or a current vehicle door state. The acquisition of the current vehicle door state can include determining the current vehicle door state according to a current motor state, the disturbing force, and a vehicle body attitude, where the current motor state includes at least a present motor current. The method continues with the step of S730 determining an operating mode of the vehicle door during operation according to the input instruction and/or the current vehicle door state, where the operating mode includes at least a suspending mode, an assist mode, and an electric mode. The next step of the method is S740 determining a vehicle door operating effect according to the operating mode. The method continues by S750 planning an operation trajectory of the vehicle door when determining that the operating mode is the electric mode. In more detail, when a door opening button on a vehicle key or a door opening button on a door handle is pressed, it may be determined that the operating mode of the vehicle door during the operation is the electric mode, and then the operation trajectory of the vehicle door may be planned. For example, the operation trajectory of the vehicle door is stored in a controller during delivery of a vehicle. A plurality of operation trajectories of the vehicle door may be stored in the controller for selection by the controller and the user.

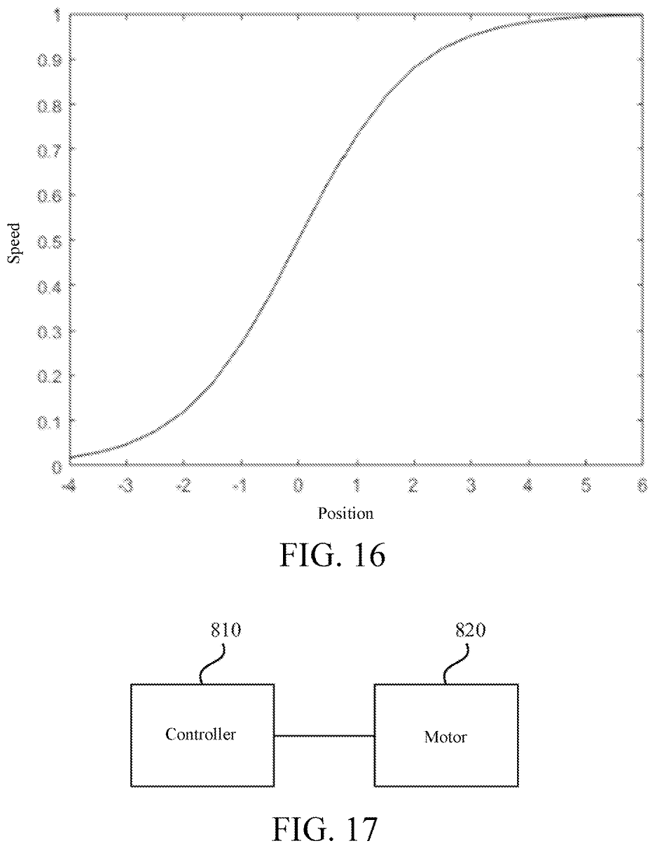

FIG. 16 is a schematic diagram of a vehicle door operation trajectory according to an embodiment of the present invention. Referring to FIG. 16, the speed and the acceleration of the vehicle door are relatively small at a beginning of the operation, and the speed is increasingly larger during the operation. When the vehicle door is close to the target position, the speed of the vehicle door speed is relatively large and the acceleration is very small. Therefore, planning the operation trajectory of the vehicle door can realize control of the operating speed and the acceleration of the vehicle door. A specific operation trajectory of the vehicle door may be determined according to an actual situation. Only one operation trajectory is shown in FIG. 16, which is not limited.

Referring back to FIG. 15, the method proceeds with the step of S760 determining a target position and a target speed of the vehicle door according to the operation trajectory. More specifically, the target position of the vehicle door may be determined according to the operation trajectory of the vehicle door, and the target speed and the target acceleration of the vehicle door during the operation may be determined. The target speed and the target acceleration of the vehicle door may be fixed values. When the target speed is a fixed value, the vehicle door operates at a constant speed. When the target acceleration of the vehicle door is a fixed value, the vehicle door may operate at a constant acceleration. The target speed and the target acceleration of the vehicle door may alternatively not be fixed values, and may be determined according to an actual situation, which is not limited herein.

The method continues by S770 determining target current information of a motor of the vehicle door according to the target position, the target speed, the current motor state, the disturbing force, the current vehicle door state, and the vehicle door operating effect. Specifically, double PI control may be performed on the target position and the target speed, to obtain the target current information. The current motor state includes, for example, a present motor current. The present motor current may be used as a negative feedback of the double PI control, which can reduce the error of the outputted target current information, thereby obtaining more accurate target current information. The target current information may be adjusted according to the disturbing force, and the target current information may alternatively be adjusted according to the current vehicle door state and the vehicle door operating effect, which can reduce the error of the target current information, thereby realizing the vehicle door operating effect more accurately, and realizing the accurate control of the vehicle door.

The next step of the method is S780 determining target voltage information according to the target current information. The method also includes the step of S790 controlling the motor to operate according to the target voltage information, so that the motor drives the vehicle door to operate.

FIG. 17 is a schematic diagram of a vehicle door control system according to an embodiment of the present invention. As shown in FIG. 17, the vehicle door control system includes a controller 810 and a motor 820. The controller 810 is configured to calibrate a disturbing force of a vehicle door, where the disturbing force includes at least a frictional force, a gravity, and a wind power. The controller 810 is further configured to determine an operating mode of a vehicle door during operation according to an input instruction and/or a current vehicle door state, where the operating mode includes at least a suspending mode, an assist mode, and an electric mode. The controller 810 is further configured to determine a vehicle door operating effect according to the operating mode. The controller 810 is further configured to determine target voltage information of a motor of the vehicle door according to the operating mode, the disturbing force, the current vehicle door state, and the vehicle door operating effect. The controller 810 is electrically connected to the motor 820. The controller 810 is further configured to control operation of the motor 820 according to the target voltage information, so that the motor 820 drives the vehicle door to operate.

The vehicle door system provided in this embodiment can realize the vehicle door control method in the above technical solution. An implementation principle and a technical effect of the vehicle door control system provided in this embodiment are similar to those of the above technical solution, and therefore are not repeated herein.

Note that the above is only preferred embodiments of the present invention and the applied technical principle. Those skilled in the art will understand that the present invention is not limited to the specific embodiments described here, and that it is possible for those skilled in the art to make various obvious changes, readjustments and substitutions without departing from the scope of protection of this invention. Therefore, although the present invention has been described in more detail through the above embodiments, the invention is not limited to the above embodiments. Without departing from the concept of the invention, it can also include more equivalent embodiments, and the scope of the invention is determined by the scope of the appended claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A vehicle door control method, comprising:
calibrating a disturbing force of a vehicle door, wherein the disturbing force comprises at least a frictional force, a gravity, and a wind power;
determining an operating mode of the vehicle door during operation according to an input instruction and/or a current vehicle door state, wherein the operating mode comprises at least a suspending mode, an assist mode, and an electric mode;
determining a vehicle door operating effect according to the operating mode;
determining target voltage information of a motor of the vehicle door according to the operating mode, the disturbing force, the current vehicle door state, and the vehicle door operating effect; and
controlling the motor to operate according to the target voltage information, so that the motor drives the vehicle door to operate.

2. The vehicle door control method according to claim 1, wherein before the determining an operating mode of the vehicle door during operation according to an input instruction and/or a current vehicle door state, the method further comprises:
acquiring the input instruction and/or the current vehicle door state, wherein
the acquiring the current vehicle door state comprises:
determining the current vehicle door state according to a current motor state, the disturbing force, and a vehicle body attitude, wherein the current motor state comprises at least a present motor current.

3. The vehicle door control method according to claim 2, wherein the determining target voltage information of a motor of the vehicle door according to the operating mode, the disturbing force, the current vehicle door state, and the vehicle door operating effect comprises:
determining target current information of the motor of the vehicle door according to the operating mode, the disturbing force, the current vehicle door state, and the vehicle door operating effect; and
determining the target voltage information according to the target current information.

4. The vehicle door control method according to claim 3, wherein the determining target current information of the motor of the vehicle door according to the operating mode, the disturbing force, the current vehicle door state, and the vehicle door operating effect comprises:
determining a target suspending position when determining that the operating mode is the suspending mode;
determining a suspending manner of the vehicle door according to the current vehicle door state, wherein the suspending manner comprises emergency suspension and smooth suspension;
determining an operation trajectory of the vehicle door according to the target suspending position and the suspending manner;
determining a target speed of the motor according to the operation trajectory of the vehicle door, the disturbing force, the current vehicle door state, and the vehicle door operating effect; and
determining the target current information according to the target speed and the present motor current.

5. The vehicle door control method according to claim 4, wherein the determining the target current information according to the target speed and the present motor current comprises:
performing fuzzification and proportional-integral control on the target speed and the present motor current, to determine the target current information.

6. The vehicle door control method according to claim 5, wherein the performing fuzzification and proportional-integral control on the target speed and the present motor current, to determine the target current information comprises:
obtaining a target acceleration according to the target speed;
performing fuzzification on the target speed and the target acceleration, to obtain a proportional parameter and an integral parameter; and
performing proportional-integral control on the target speed, the proportional parameter, the integral parameter, and the present motor current, to determine the target current information.

7. The vehicle door control method according to claim 3, wherein the determining target current information of the motor of the vehicle door according to the operating mode, the disturbing force, the current vehicle door state, and the vehicle door operating effect comprises:
determining an assist parameter when determining that the operating mode is the assist mode; and
determining the target current information of the motor of the vehicle door according to the assist parameter, the disturbing force, the current vehicle door state, and the vehicle door operating effect.

8. The vehicle door control method according to claim 3, wherein the determining target current information of the motor of the vehicle door according to the operating mode, the disturbing force, the current vehicle door state, and the vehicle door operating effect comprises:
planning an operation trajectory of the vehicle door when determining that the operating mode is the electric mode;
determining a target position and a target speed of the vehicle door according to the operation trajectory; and
determining the target current information of the motor of the vehicle door according to the target position, the target speed, the current motor state, the disturbing force, the current vehicle door state, and the vehicle door operating effect.

9. The vehicle door control method according to claim 3, wherein the determining the target voltage information according to the target current information comprises:
determining DC voltage information according to the target current information;
transforming the DC voltage information to space AC voltage information; and
transforming the space AC voltage information to space vector pulse width modulation (SVPWM) information; and
determining the target voltage information according to the SVPWM information.

10. A vehicle door control system, comprising:
a motor of a vehicle door;
a controller electrically connected to the motor, the controller configured to:
calibrate a disturbing force of the vehicle door, wherein the disturbing force comprises at least a frictional force, a gravity, and a wind power,
determine an operating mode of the vehicle door during operation according to an input instruction and/or a current vehicle door state, wherein the operating mode comprises at least a suspending mode, an assist mode, and an electric mode,
determine a vehicle door operating effect according to the operating mode,
determine target voltage information of the motor of the vehicle door according to the operating mode, the disturbing force, the current vehicle door state, and the vehicle door operating effect, and
control the motor to operate according to the target voltage information, so that the motor drives the vehicle door to operate.

11. The vehicle door control system according to claim 10, wherein before determining an operating mode of the vehicle door during operation according to an input instruction and/or a current vehicle door state, the controller is further configured to:
acquire the input instruction and/or the current vehicle door state, wherein
to acquire the current vehicle door state the controller is configured to:
determine the current vehicle door state according to a current motor state, the disturbing force, and a vehicle body attitude, wherein the current motor state comprises at least a present motor current.

12. The vehicle door control system according to claim 11, wherein to determine target voltage information of a motor of the vehicle door according to the operating mode, the disturbing force, the current vehicle door state, and the vehicle door operating effect, the controller is further configured to:
determine target current information of the motor of the vehicle door according to the operating mode, the disturbing force, the current vehicle door state, and the vehicle door operating effect; and
determine the target voltage information according to the target current information.

13. The vehicle door control system according to claim 12, wherein to determine target current information of the motor of the vehicle door according to the operating mode, the disturbing force, the current vehicle door state, and the vehicle door operating effect, the controller is further configured to:
determine a target suspending position when determining that the operating mode is the suspending mode;
determine a suspending manner of the vehicle door according to the current vehicle door state, wherein the suspending manner comprises emergency suspension and smooth suspension;
determine an operation trajectory of the vehicle door according to the target suspending position and the suspending manner;
determine a target speed of the motor according to the operation trajectory of the vehicle door, the disturbing force, the current vehicle door state, and the vehicle door operating effect; and
determine the target current information according to the target speed and the present motor current.

14. The vehicle door control system according to claim 13, wherein to determine the target current information according to the target speed and the present motor current, the controller is further configured to:
perform fuzzification and proportional-integral (PI) control on the target speed and the present motor current, to determine the target current information.

15. The vehicle door control system according to claim 14, wherein to perform fuzzification and proportional-integral control on the target speed and the present motor current, to determine the target current information, the controller is further configured to:
obtain a target acceleration according to the target speed;
perform fuzzification on the target speed and the target acceleration, to obtain a proportional parameter and an integral parameter; and
perform proportional-integral control on the target speed, the proportional parameter, the integral parameter, and the present motor current, to determine the target current information.

16. The vehicle door control system according to claim 13, wherein the controller is further configured to:
determine whether the operating mode is the electric mode;
determine whether the vehicle door is close to the target suspending position according to the current vehicle door state;
determine whether the current vehicle door state is that an obstacle exists near the vehicle door;
control the operating mode of the vehicle door to become the suspending mode, and control the vehicle door to suspend at the target suspending position in response to determining the operating mode is the electric mode and determining that the vehicle door is close to the target suspending position according to the current vehicle door state, or determining that the current vehicle door state is that the obstacle exists near the vehicle door.

17. The vehicle door control system according to claim 12, wherein to determine target current information of the motor of the vehicle door according to the operating mode, the disturbing force, the current vehicle door state, and the vehicle door operating effect, the controller is further configured to:
determine an assist parameter when determining that the operating mode is the assist mode; and
determine the target current information of the motor of the vehicle door according to the assist parameter, the disturbing force, the current vehicle door state, and the vehicle door operating effect.

18. The vehicle door control system according to claim 12, wherein to determine target current information of the motor of the vehicle door according to the operating mode, the disturbing force, the current vehicle door state, and the vehicle door operating effect, the controller is further configured to:
plan an operation trajectory of the vehicle door when determining that the operating mode is the electric mode;
determine a target position and a target speed of the vehicle door according to the operation trajectory; and
determine the target current information of the motor of the vehicle door according to the target position, the target speed, the current motor state, the disturbing force, the current vehicle door state, and the vehicle door operating effect.

19. The vehicle door control system according to claim 12, wherein to determine the target voltage information according to the target current information, the controller is further configured to:
determine DC voltage information according to the target current information;
transform the DC voltage information to space AC voltage information; and
transform the space AC voltage information to space vector pulse width modulation (SVPWM) information; and
determine the target voltage information according to the SVPWM information.

20. The vehicle door control system according to claim 10, wherein the controller is a variable frequency controller.
